(19) United States
(12) Patent Application Publication
(10) Pub. No.: US 2008/0284817 A1
(43) Pub. Date: Nov. 20, 2008

(54) MAINTENANCE STATION OF INKJET PRINTER

(76) Inventors: Kuo-Kuang Wu, Hsinchu (TW); Wei-Yuan Peng, Hsinchu (TW); Wei-Fong Lin, Hsinchu (TW)

Correspondence Address: BIRCH STEWART KOLASCH & BIRCH, PO BOX 747, FALLS CHURCH, VA, 22040-0747, US

(21) Appl. No.: 11/748,990

(22) Filed: May 15, 2007

(51) Int. Cl. B41J 2/165

(52) U.S. Cl. 347/36

(57) ABSTRACT

A maintenance station of inkjet printer includes a supporter, an ink cup pivoted on the supporter and configured to receive waste ink, a driver and a preventing arm. The ink cup has a circular board and a ring. The circular board is pivoted on the supporter. The ring has a belt fixed on the outer edge of the circular board and a plurality of elastic arms. Each of the elastic arms has a base extended vertically from the belt and an inclined portion bent from the end of the base inclinedly. The driver is configured to push the inclined portion to rotate the ink cup. The preventing arm is configured to press the inclined portion to permit the ink cup to be rotated and push the inclined portion to prevent the ink cup from being rotated.

### BACKGROUND OF THE INVENTION

1. Field of the Invention

This present invention relates generally to an inkjet printer, and more particularly to a maintenance station of inkjet printer for receiving waste ink from a printing head.

2. The Related Art

Inkjet printers require maintenance station to receive waste ink from a printing head before starting to print, and to wipe the nozzle area of the printing head to keep the area clean and to cover the printing head to avoid ink evaporating after printing.

Referring to FIG. 1, a prior maintenance station is shown. The maintenance station has two scrapers 21, two caps 22 and an ink cup 30. The scrapers 21 are used to wipe the nozzle area of printing heads of the printer to keep the area clean. The caps 22 are used to cover the corresponding printing head to avoid ink evaporating. The ink cup 30 is used to receive waste ink from the printing heads.

Referring to FIG. 2 and FIG. 3, the ink cup 30 is pivoted on a shaft 33, and a space is defined between the ink cup 30 and the shaft 33. A driver 40 is provided for rotating the ink cup 30 for receiving waste ink evenly. A preventing arm 43 is provided for pushing the ink cup 30 to prevent the ink cup 30 from being rotated at appropriate time.

When the driver 40 is moved along the direction of arrow shown in FIG. 2, because there is a space between the ink cup 30 and the shaft 33 the driver 40 pushes the ink cup 30 to the top left to separate the ink cup 30 from the preventing arm 43, as a result, the driver 40 drives the ink cup 30 to rotate. When the driver 40 is moved along the direction of arrow shown in FIG. 3, the ink cup 30 moves to the bottom right, and the preventing arm 43 pushes the ink cup 30, as a result, the preventing arm 43 can prevent the ink cup 30 from being rotated reversely.

Because the space defined between the ink cup 30 and the shaft 33 and the place of the preventing arm 43 placed need to control accurately, otherwise, the ink cup 30 can not be rotated or is rotated reversely at the driver 40 moving along the direction of arrow shown in FIG. 3.

### SUMMARY OF THE INVENTION

To solve the above-mentioned problems, according to one embodiment of the present invention, the present invention provides a maintenance station of inkjet printer including a supporter, an ink cup, a driver and a preventing arm. The ink cup has a circular board and a ring. The circular board is pivoted on the supporter. The ring has a belt fixed on the outer edge of the circular board and a plurality of elastic arms. Each of the elastic arms has a base extended vertically from the belt and an inclined portion bent from the end of the base inclinedly. The driver is configured to push the inclined portion to rotate the ink cup. The preventing arm is configured to press the inclined portion to permit the ink cup to be rotated and push the inclined portion to prevent the ink cup from being rotated.

Accordingly, the inclined portion of the elastic arm is bent from the end of the base inclinedly, therefore the inclined portion is easy to turn around the connecting portion of the base and the inclined portion in the normal direction of the ink cup, and is difficult to turn in the tangential direction of the ink cup. The driver presses the inclined portion in the normal direction, and the preventing arm pushes the inclined portion in the tangential direction to prevent the ink cup from being rotated. The driver pushes the inclined portion in the tangential direction, and the preventing arm presses the inclined portion in the normal direction to permit the ink cup to being rotated. Therefore, the present invention can avoid the ink cup being rotated in the wrong direction or not being rotated.

### BRIEF DESCRIPTION OF THE DRAWINGS

The invention, together with its objects and the advantages thereof may be best understood by reference to the following description taken in conjunction with the accompanying drawings, in which:

FIG. 1 is a perspective view of a prior maintenance station of inkjet printer;

FIG. 2 to FIG. 3 are bottom view of the ink cup of the prior maintenance station of inkjet printer, illustrating the movement of the ink cup;

FIG. 4 is a perspective view of a maintenance station of inkjet printer of the present invention;

FIG. 5 is another perspective view of the maintenance station of inkjet printer shown in FIG. 4;

FIG. 6 is a front view of the maintenance station of inkjet printer shown in FIG. 4;

FIG. 7 is an exploded view of the maintenance station of inkjet printer shown in FIG. 4; and

FIG. 8 to FIG. 9 are bottom view of the ink cup of the maintenance station of inkjet printer shown in FIG. 4, illustrating the movement of the ink cup.

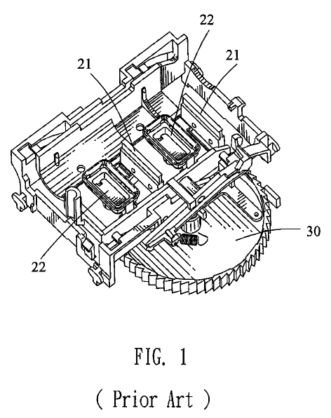

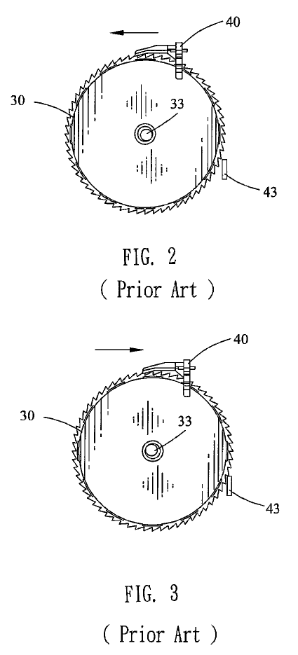

### DETAILED DESCRIPTION OF THE PREFERRED EMBODIMENT

The embodiment of the present invention will be described below in detail with reference to the accompanying drawings. It goes without saying, however, that the present invention is not limited to the following embodiment and can be arbitrarily modified without departing from the scope and spirit of the present invention.

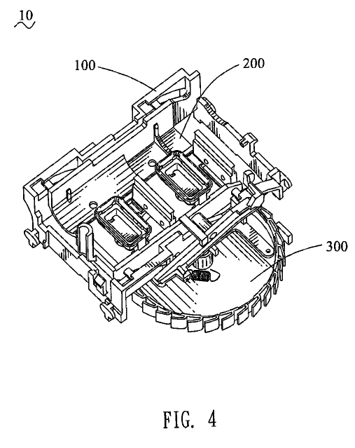

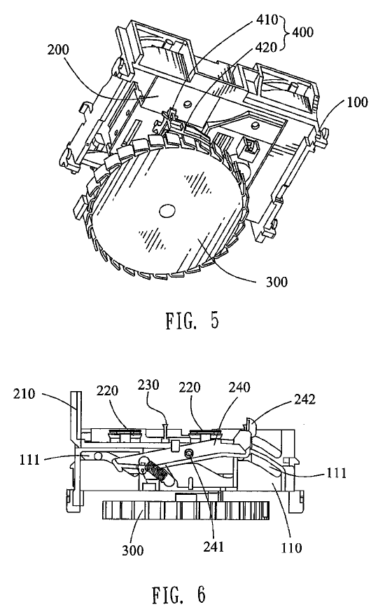

First referring to FIG. 4 and FIG. 5, a maintenance station 10 includes a supporter 100, a maintenance system 200 disposed in the supporter 100, an ink cup 300 pivoted on the supporter 100, and a driver 400 fixed on the maintenance system 200.

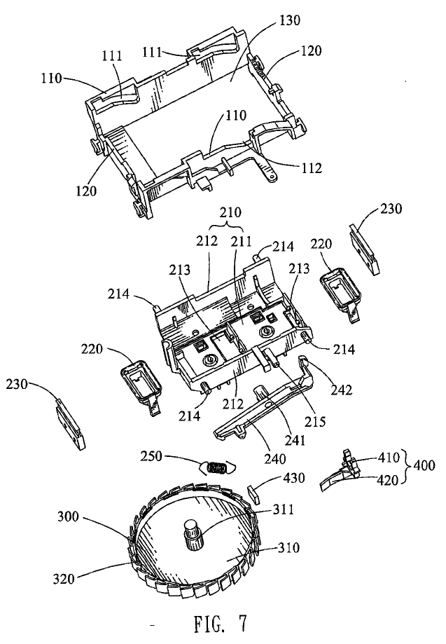

Referring to FIG. 6 and FIG. 7, the supporter 100 has a pair of braces 110 and a pair of linking boards 120 which are fixed vertically on the end of the corresponding brace 110 to form a housing 130. Each of the braces 110 defines two slots 111 extending to the top left. The front brace 110 also defines an indentation 112 in the middle thereof.

The maintenance system 200 has a movable seat 210, two caps 220, two scrapers 230, a bolt 240 and a tension spring 250. The movable seat 210 is disposed in the housing 130, which has a bottom wall 211 and two side walls 212 extending vertically from the front and back edges of the bottom wall 211 respectively. Two openings 213 are defined respectively at the middle area and right area of the bottom wall 211. Each of the side walls 110 provides two sliding shafts 214 which are inserted in the corresponding slots 111 to lead the movable seat 210 to slide, and the front side walls 110 also provides a pivot 215. The caps 220 and scrapers 230 are fixed respectively on the bottom wall 211 and arranged respectively on two sides of the corresponding opening 213.

The bolt 240 provides a pivot seat 241 at the middle thereof which passes through the indentation 112 and connects with the pivot 215 pivotally. A lump 242 is formed at the right end of the bolt 240. The right side of lump 242 is shaped into a curve, and the left side of the lump 242 is shaped into a vertical plane. Two ends of the tension spring 250 clasp the left end of the bolt 240 and the supporter 100 respectively.

The ink cup 300 has a circular board 310 and a ring 320. A bearing 311 is extended vertically at the middle of the circular board 310, through which the ink cup 300 is pivoted on the supporter 100 and located under the maintenance system 200. The ring 320 has a belt 321 and a plurality of elastic arms 322 extended from the outer side edge of the belt 321. The belt 321 is fixed vertically on the outer edge of the circular board 310 to form a cup, therefore the ink cup 300 can be used to hold waste ink from printing heads of a printer. Each of the elastic arms 322 has a base 323 and an inclined portion 324. The base 323 is extended along the normal direction of the belt 321, that is to say, the base 323 is vertical to the belt 321. The inclined portion 324 is bent from the end of the base 323 and extended along the normal and tangential direction of the belt 321, that is to say, there is an obtuse angle between the inclined portion 324 and the base 323. Because the inclined portion 324 is inclined relative to the base 323, the inclined portion 324 is easy to turn around the connecting portion of the base 323 and the inclined portion 324 in the normal direction, and is difficult to turn the tangential direction.

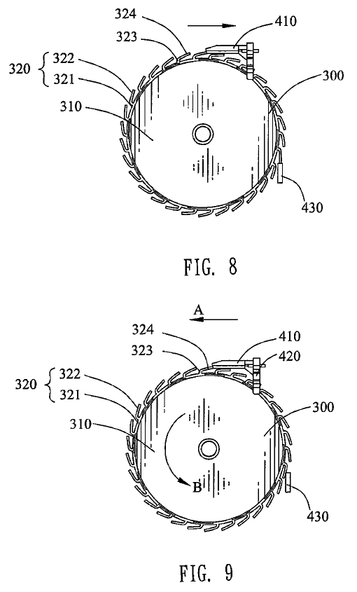

The driver 400 has a fixed arm 410 and a driving arm 420 fixed on the fixed arm 410 vertically. The fixed arm 410 is fixed on the bottom wall 211 of the movable seat 210 as shown in FIG. 5, therefore the driver 400 can be moved following with the movable seat 210. The driving arm 420 can be against the inclined portion 324 in the tangential direction to rotate the ink cup 300. A preventing arm 430 is placed a properly place, which can press the inclined portion 324 in the normal direction to permit the ink cup 300 to being rotated and be against the inclined portion 324 in the tangential direction to prevent the ink cup 300 from being rotated, as shown in FIG. 8 and FIG. 9.

Referring to FIG. 6, FIG. 8 and FIG. 9, when the printer is work, the printing heads of the printer are moved to the right. One printing head is against the left side of lump 242 and urges the bolt 240 to move to the right. The movable seat 210 moves to the bottom right along the slots 111 under the pushing force of the pivot seat 241 of the bolt 240. In the above course, the printing heads come off the caps 220 respectively and eject ink that is called waste ink. The waste ink passes through the openings 213 and is received by the circular board 310 of the ink cup 300. At the same time, the driver 400 is moved along the direction of arrow shown in FIG. 8. The driving arm 420 presses the inclined portion 324 in the normal direction, and the preventing arm 430 pushes the inclined portion 324 in the tangential direction. Because the inclined portion 324 is easy to turn around the connecting portion of the base 323 and the inclined portion 324 in the normal direction, and is difficult to turn the tangential direction, the driver 400 can be moved, and the preventing arm 430 can prevent the ink cup 300 from being rotated.

After finishing the printing, the printing heads of the printer are moved to the left. Another printing head is against the right side of lump 242 and urges the bolt 240 to move to the left. The movable seat 210 moves to the top left along the slots 111 under the pushing force of the pivot seat 241 of the bolt 240. In the above course, the scrapers 230 wipe the nozzle area of the corresponding printing head to keep the area clean, and the caps 220 cover the corresponding printing head to prevent ink from evaporating. At the same time, the driver 400 is moved along the direction of arrow A shown in FIG. 9. The driving arm 420 pushes the inclined portion 324 in the tangential direction, and the preventing arm 430 presses the inclined portion 324 in the normal direction to bend the inclined portion 324, therefore the driving arm 420 pushes the ink cup 300 to be rotated along the direction of arrow B shown in FIG. 9.

According the above description, the inclined portion 324 of the elastic arm 322 is bent from the end of the base 323 inclinedly, therefore the inclined portion 324 is easy to turn around the connecting portion of the base 323 and the inclined portion 324 in the normal direction, and is difficult to turn in the tangential direction. When the driver 400 is moved along the inclined direction of the inclined portion 324, the driving arm 420 presses the inclined portion 324 in the normal direction, and the preventing arm 430 pushes the inclined portion 324 in the tangential direction to prevent the ink cup 300 from being rotated. When the driver 400 is moved along the opposite inclined direction, the preventing arm 430 presses the inclined portion 324 in the normal direction, and the driving arm 420 pushes the inclined portion 324 in the tangential direction to rotate the ink cup 300. Therefore, the present invention can avoid the ink cup 300 being rotated in the wrong direction and not being rotated.

The embodiment of the present invention have been discussed in detail. However, the embodiment is merely one specific example for clarifying the technical contents of the present invention and the present invention is not to be construed in a restricted sense as limited to this specific example. Thus, the spirit and scope of the present invention are limited only by the appended claims.

What is claimed is:

1. A maintenance station of inkjet printer, comprising:
a supporter;
an ink cup provided to receive waste ink, the ink cup having a circular board and a ring, the circular board pivoted on the supporter, the ring having a belt fixed on the outer edge of the circular board;
an elastic arm extended from the ring, having a base extended vertically from the belt and an inclined portion bent from the end of the base inclinedly;
a driver configured to push the inclined portion to rotate the ink cup; and
a preventing arm configured to press the inclined portion to permit the ink cup to be rotated and push the inclined portion to prevent the ink cup from being rotated.

2. The maintenance station of inkjet printer according to the claim 1, wherein the base is extended vertically from the outer side edge of the belt.
